(19) United States
(12) Patent Application Publication
(10) Pub. No.: US 2019/0315154 A1
(43) Pub. Date: Oct. 17, 2019

(54) Paint Roller Cleaning Tool

(71) Applicant: Angela Terry, Bethlehem, GA (US)

(72) Inventor: Angela Terry, Bethlehem, GA (US)

(21) Appl. No.: 16/274,430

(22) Filed: Feb. 13, 2019

Related U.S. Application Data
(60) Provisional application No. 62/657,465, filed on Apr. 13, 2018.

(51) Int. Cl. B44D 3/00

(52) U.S. Cl. CPC B44D 3/006; B05C 17/0245

(57) ABSTRACT

A paint roller cleaning tool. The paint roller cleaning tool has an upper edge and a lower edge with a pair of opposing side edges. At least one arcuate extension is on the upper edge. The arcuate extension is designed to receive a paint roller and to remove paint from the paint roller. A pair of notches extend into the lower edge. The pair of notches are designed to secure the paint roller cleaning tool in a paint container, such as a paint can.

### CROSS REFERENCE TO RELATED APPLICATIONS

This application claims the benefit of U.S. Provisional Application No. 62/657,465 filed on Apr. 13, 2018. The above identified patent application is herein incorporated by reference in its entirety to provide continuity of disclosure.

### BACKGROUND OF THE INVENTION

The present invention relates to a paint roller cleaning tool. More specifically, the present invention relates to a paint roller cleaning tool that provides an arcuate recession that is configured to clean paint from a paint roller combined with a pair of notches designed to secure the paint roller cleaning tool partially inside of a paint container itself.

Paint rollers are a useful tool to painters and other contractors when painting a large area, or a hard to reach area, such as a wall, a ceiling or a floor. Furthermore, detail paint rollers may be used in other projects for convenience, as well to create a specific pattern. Typically, when paint rollers are utilized, the sleeve portion of the paint roller will absorb a significant amount of paint. If this paint is not removed from the sleeve and is left to dry, the sleeve can become unusable or may require the use of chemicals or excessive physical effort or a combination thereof to remove the dried paint.

On one hand, discarding a paint roller because it has retained paint that has dried is wasteful. Not only is the sleeve itself disposed of, requiring the painter to obtain a new sleeve for future products, but the paint itself that is in the sleeve is also disposed of. On the other hand, traditional methods of reclaiming unused paint can lead to large messes, causing the painter to allot additional time for cleaning up, as well as potential frustration.

Therefore, there is a need in the known art for a paint roller cleaning device that is more efficient and effective than the devices provided in the known art. Furthermore, the device should provide convenience to a user not only in assisting in cleaning but should be easy to use and freely transportable.

### SUMMARY OF THE INVENTION

In view of the foregoing disadvantages inherent in the known types of paint roller cleaning devices now present in the prior art, the present invention provides a paint roller cleaning tool wherein the same can be utilized for providing convenience for the user when cleaning a paint roller.

The present system comprises a paint roller cleaning tool. The paint roller cleaning tool comprises a planar base. The planar base has an upper edge disposed oppositely a lower edge. Additionally, the planar base has a pair of opposing side edges. At least one arcuate extension is disposed in the upper edge of the planar base. A first notch and a second notch are disposed on the lower edge of the planar base. The first notch and the second notch are disposed adjacent to each of a first side edge and a second side edge, respectively.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of an embodiment of the paint roller cleaning tool.

FIG. 2 shows a perspective view of an embodiment of the paint roller cleaning tool.

FIG. 3 shows a perspective view of an embodiment of the paint roller cleaning tool in use.

### DETAILED DESCRIPTION OF THE INVENTION

Reference is made herein to the attached drawings. Like reference numerals are used throughout the drawings to depict like or similar elements of the paint roller cleaning tool. The figures are intended for representative purposes only and should not be considered to be limiting in any respect.

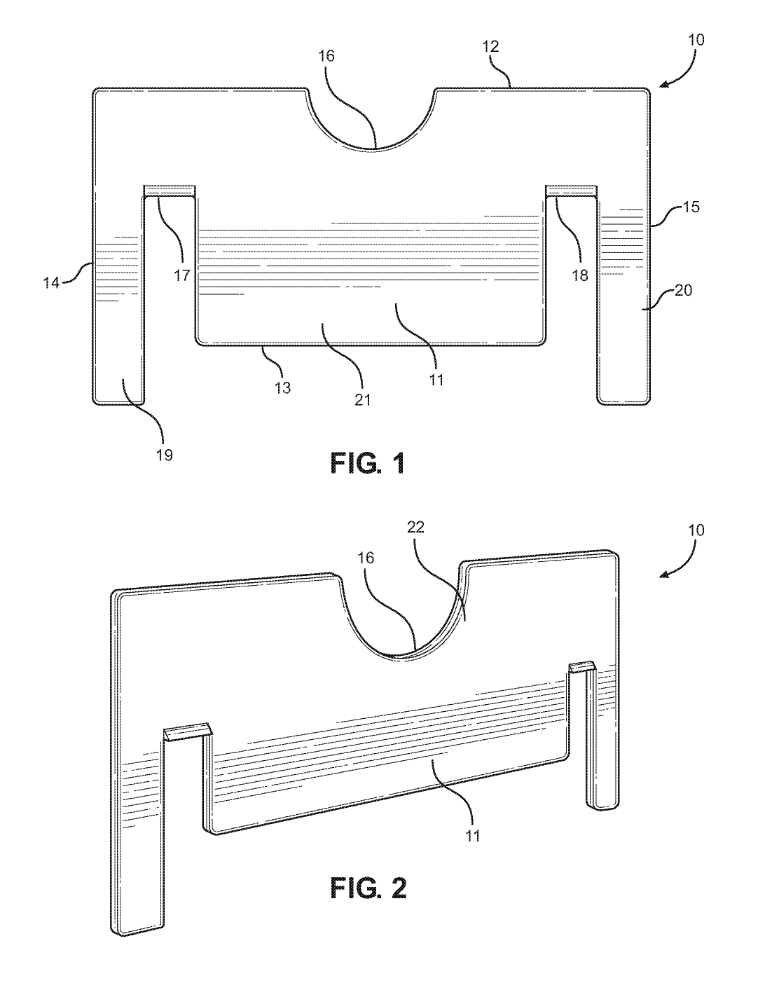

Referring now to FIG. 1, there is shown a front view of an embodiment of the paint roller cleaning tool. The paint roller cleaning tool 10 comprises a planar base 11 having an upper edge 12 disposed oppositely a lower edge 13. Furthermore, the paint roller cleaning tool 10 comprises a pair of opposing side edges 14, 15.

At least one arcuate recession 16 is disposed on the upper edge 12 of the planar base 11. In the illustrated embodiment, a singular arcuate recession 16 is disposed centrally on the upper edge 12 of the planar base 11. In an alternate embodiment, a plurality of arcuate recessions 16 is provided. In one embodiment, the plurality of arcuate recessions 16 each comprise an identical circumference. Alternatively, in another embodiment, the plurality of arcuate recessions 16 each comprise a different circumference.

A first notch 17 and a second notch 18 are disposed on the lower edge 13 of the planar base 11. The first notch 17 is disposed adjacently to a first side edge 14. The second notch 18 is disposed adjacently to a second side edge 15. The first notch 17 and the second notch 18 are dimensioned to receive a side all of a paint can therein.

In the illustrated embodiment, a first extension 19 of the planar base 11 is formed between the first side edge 14 and the first notch 17. A second extension 20 is formed between the second side edge 15 and the second notch 18. A central extension 21 is formed between the first notch 17 and the second notch 18.

In the illustrated embodiment, the first extension 19 and the second extension 20 extend an equivalent linear distance from the upper edge 12 of the planar base 11. Additionally, in the shown embodiment, the first extension 19 and the second extension 20 extend a greater linear distance from the upper edge 12 of the planar base 11 than the central extension 21. Through such variations in linear distance, the amount of stability provided to the planar base 11 is variably adjusted to provide convenience for the user.

Referring now to FIG. 2, there is shown a perspective view of an embodiment of the paint roller cleaning tool. In the illustrated embodiment, the arcuate recession 16 comprises a uniformly smooth surface. In an alternate embodiment, the arcuate recession 16 comprises at least one tine thereon. The at least one tine is configured to assist a user in removing paint from a paint roller when the paint roller is engaged with the arcuate recession 16.

Additionally, in one embodiment, the paint roller cleaning tool 10 comprises a lip 22 disposed around at least a portion of a perimeter of the planar base 11. In the illustrated embodiment, the lip 22 is disposed around the arcuate recession 16. In an alternate embodiment, the lip 22 extends entirely around the perimeter of the planar base 11. The lip 22 provides convenience to a user by acting to further assist in removing excess paint from a paint roller that is engaged with the arcuate recession 16.

In one embodiment, the planar base 11 is composed of a rigid material. When the planar base 11 is made of a rigid material, the planar base 11 will be more strongly secured in the paint can. In an alternate embodiment, the planar base 11 is composed of a flexible material. When made of a flexible material, the planar base 11 is more flexible allowing for the planar base to be more easily manipulated when placed into a paint can.

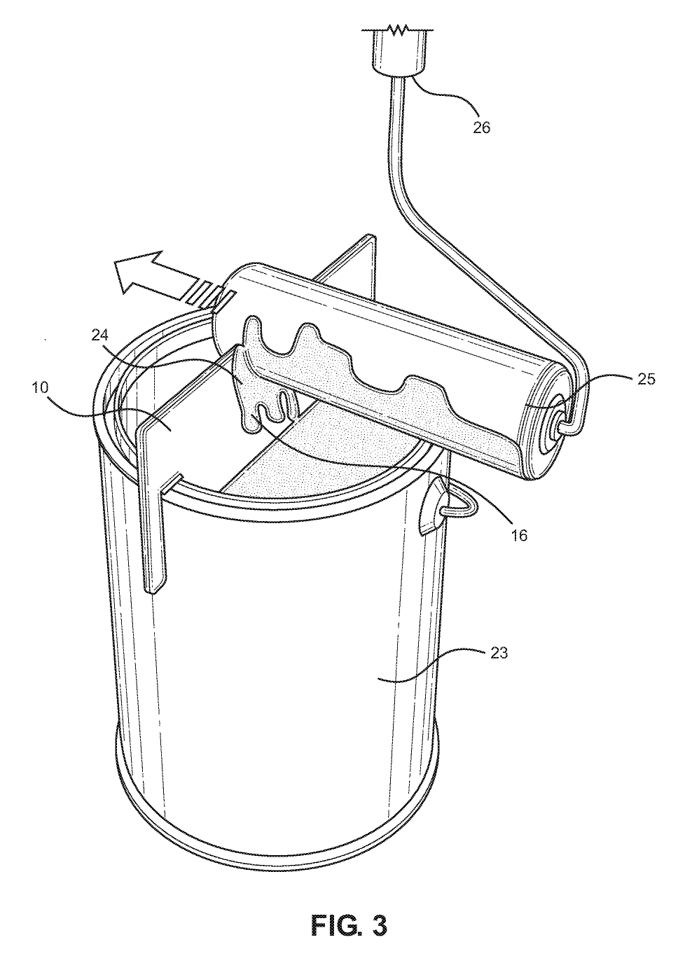

Referring now to FIG. 3, there is shown a perspective view of an embodiment of the paint roller cleaning tool in use. In use, the paint roller cleaning tool 10 is placed into a paint container 23. In the illustrated embodiment, the paint container 23 is a paint can. The arcuate recession 16, being disposed on the upper edge of the planar base, is disposed over the paint container 23, such that excess paint 24 will flow downward into an opening of the paint container 23 when a sleeve 25 of a paint roller 26 is inserted therein.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A paint roller cleaning tool, comprising:
a planar base having an upper edge disposed oppositely a lower edge;
the planar base having a pair of opposing side edges;
at least one arcuate recession disposed on the upper edge of the planar base;
a first notch and a second notch disposed on the lower edge of the planar base; and
each of the first notch and the second notch being disposed adjacent to each opposing side edge.

2) The paint roller cleaning tool of claim 1 wherein:
a first extension of the planar base is formed between a first opposing side edge and the first notch;
a second extension of the planar base is formed between the second opposing side edge and the second notch;
a central extension is formed between the first notch and the second notch; and
wherein the first extension and the second extension extend an identical linear distance from the upper edge of the planar base.

3) The paint roller cleaning tool of claim 2, wherein the first extension and the second extension extend a greater linear distance from the upper edge of the planar base than the central extension.

4) The paint roller cleaning tool of claim 1, wherein the arcuate recession is centrally disposed on the upper edge of the planar base.

5) The paint roller cleaning tool of claim 1, wherein the arcuate recession comprises a uniformly smooth surface.

6) The paint roller cleaning tool of claim 1, wherein the arcuate recession comprises a plurality of tines thereon.

7) The paint roller cleaning tool of claim 1, further comprising a lip around at least a portion of a perimeter of the planar base.

8) The paint roller cleaning tool of claim 7, wherein the lip is disposed around the arcuate recession.

9) The paint roller cleaning tool of claim 7, wherein the lip is disposed entirely around the perimeter of the planar base.

10) The paint roller cleaning tool of claim 1, wherein a plurality of arcuate recessions is provided in the upper edge of the planar base.

11) The paint roller cleaning tool of claim 10, wherein each arcuate recession of the plurality of arcuate recessions is of an identical circumference.

12) The paint roller cleaning tool of claim 10, wherein each arcuate recession of the plurality of arcuate recessions is of a different circumference.

13) The paint roller cleaning tool of claim 1, wherein the planar base is composed of a rigid material.

14) The paint roller cleaning tool of claim 1, wherein the planar base is composed of a flexible material.
